(19) United States
(12) Patent Application Publication
(10) Pub. No.: US 2002/0047351 A1
(43) Pub. Date: Apr. 25, 2002

(54) Method of starting brushless DC motor on the basis of induced voltage in armature coil for detection of position of rotor

(75) Inventor: Norihiko Araki, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/940,731

(22) Filed: Aug. 28, 2001

(30) Foreign Application Priority Data
Aug. 30, 2000 (JP) 261054/2000

(51) Int. Cl. H02K 1/00

(52) U.S. Cl. 310/68 B

(57) ABSTRACT

A method is provided for rapidly starting a brushless DC motor including an armature coil in a stator and field magnets in a rotor. The method is composed of supplying a starting current for the armature coil while the rotor is in a stationary state, measuring an induced voltage induced in the armature coil by rotation of the rotor caused by the starting current, and supplying a drive current for the armature coil in response to the induced voltage.

### BACKGROUND OF THE INVENTION

1. Field of the Invention

The present invention is related to a method of starting a brushless DC motor. The present invention is especially related to a method of starting a brushless DC motor in which a position of the rotor is detected on the basis of an induced voltage in the armature coil.

2. Description of the Related Art

A brushless DC motor that does not contain a hall element for detecting a position of the rotor is widely used. The brushless DC motor detects a voltage induced in an armature coil by a rotation of the rotor, and determines the position of the rotor. In response to the position of the rotor, a drive current is supplied to the armature coil to rotate the rotor.

To start the brushless DC motor, various methods are proposed which does not rely on the induced voltage, since no voltage is induced in the armature coil while the rotor is in a stationary state.

A first conventional method of starting a brushless DC motor is disclosed in Japanese Laid Open Patent Application (JP-A-Heisei, 9-233885). With reference to FIG. 1A, an electric current firstly is supplied to flow from a U-phase coil 101 to a V-phase coil 102 for a short time, and thereby a rotor 103 is rotated in a direction indicated by an arrow 104. While the electric current is supplied, the rotor 103 is locked at a position shown in FIG. 1B. In succession, a drive current is supplied to flow from a W-phase coil 105 to the V-phase coil 102, and the rotor 103 begins to rotate in a counterclockwise direction. Then, the drive current is sequentially switched to the phase coils 101, 102, and 105 so that the rotor 103 is accelerated. After the increase in the rotation speed of the rotor 103, the position of the rotor 103 is detected from the electromotive voltage induced in the phase coils 101, 102 and 105 and the drive current is switched on the basis of the detected position.

In the first conventional method of starting a brushless DC motor, however, it takes a long time for the rotor 103 to be locked at a certain position. A considerable time is needed for the rotor 103 to be fixed because of inertia of the rotor 103. The time required to start a brushless DC motor is desired to be short.

A second conventional method of starting a brushless DC motor is disclosed in “Transistor Technique, February 2000” pp.221 to 228. In addition, a conventional brushless DC motor system using the second conventional method of starting a brushless DC motor is disclosed in Japanese Laid Open Patent Application (JP-A-Heisei 8-308288). As shown in Fig .2, the conventional brushless DC motor system is provided with a DC brushless motor 111, a microcomputer 112, an output unit 113, a position detector 114 and a electrically programmable memory 115. A three-phase armature current is supplied in accordance with a drive pattern stored in the memory 115. The drive pattern has no relation to a position of a rotor of the motor 111. The microcomputer 112 controls the output unit 113 in accordance with the drive pattern stored in the memory 115.

However, the conventional brushless DC motor is large in circuit size, because the memory 115 requires a large circuit size.

Moreover, the second conventional method of starting the brushless DC motor requires a long time until the rotation of the rotor is achieved. Furthermore, the second conventional method of actuating a brushless DC motor can not obtain a large actuation torque. These results from that an armature current is supplied to the armature coil in accordance with a certain drive pattern, irrespectively of the position of the rotor.

A third conventional method of starting a brushless DC motor is disclosed in the above-mentioned “Transistor Technique, February 2000” pp.221 to 228. In the third conventional method, a position of a stationary rotor is detected from an increase speed of an armature current when an armature voltage is applied to an armature coil.

FIGS. 3A, 3B and 3C show the third known method of starting a brushless DC motor. Suppose that a rotor 121 and an armature 122 of the brushless DC motor are located at positions shown in FIG. 3A.

At first, A three-phase drive voltage is applied to the armature 122 in accordance with a voltage pattern shown in FIG. 3B. The drive voltage pattern is switched at a high speed so that the rotor 122 is not rotated.

When the three-phase drive voltage is applied to the armature 121, the increase speed of the current flowing through the armature 121 depends on the position of the rotor 122. If a direction of a magnetic field generated by the armature 121 coincides with a direction of a magnetic field generated by a magnet 122a placed in the rotor 121, the current quickly increases. With reference with FIG. 3B, let us suppose that a U-phase drive voltage V_{U} is set at a power supply potential V_{cc}, and a V-phase drive voltage V_{V} is set at a ground potential, respectively at a timing (1). In this case, a U-phase coil 121a generates a magnetic flux in a direction substantially coincident with a direction of a magnetic flux generated by a magnet 122a opposite to the U-phase coil 121a. In this case, a current I_{U} flowing through the U-phase coil sharply increases, as shown in FIG. 3C.

On the other hand, if the direction of the magnetic field generated by the armature 122 does not coincide with the direction of the magnetic field generated by the magnet 122a placed in the rotor 122, the increase speed of the current is slow. As shown in FIG. 3B, at a timing (4), let us suppose that the U-phase drive voltage V_{U} is set at the ground potential, and the V-phase drive voltage V_{V} is set at the power supply potential V_{cc}, respectively. The U-phase coil 121a generates a magnetic flux in a direction opposite to the direction of the magnetic flux generated by the magnet 122a opposite to the U-phase coil 121a. In this case, the current I_{U} flowing through the U-phase coil is slow, as shown in FIG. 3C.

In this way, the increase speed of the armature current when the armature voltage is applied to the armature implies the relative position between the rotor and the armature. Thus, the position of the stationary rotor is detected from the increase speed. The motor is started on the basis of the detected position of the rotor.

A circuit for detecting the increase speed of the armature current is required in order to embody the third known method of actuating a brushless DC motor. Typically, such a circuit requires a configuration of an analog circuit. If the analog circuit is integrated into LSI, the occupation area becomes wide. Thus, if the circuit for detecting the increase speed of the current is integrated into the LSI, the area occupied by its circuit becomes wide. The size of the circuit for starting the brushless DC motor is desired to be small.

Also, a fourth conventional method of starting a brushless DC motor is disclosed in Japanese Laid Open Patent Application (Jp-A-Heisei 6-237595). In the fourth conventional method, a starting current supplied to the armature coil has a waveform determined to increase the starting torque and to avoid the failure of the start.

### SUMMARY OF THE INVENTION

Therefore, an object of the present invention is to reduce a time required to start a brushless DC motor.

Another object of the present invention is to reduce a size of a circuit required to start a brushless DC motor.

Still another object of the present invention is to reduce an area occupied by an integrated circuit for starting a brushless DC motor.

In order to achieve an aspect of the present invention, a method of starting a brushless DC motor including an armature coil in a stator and field magnets in a rotor is composed of:

supplying a starting current for the armature coil while the rotor is in a stationary state;

measuring an induced voltage induced in the armature coil by rotation of the rotor wherein the rotation is caused by the starting current; and

supplying a drive current for the armature coil in response to the induced voltage.

The supplying of the drive current preferably includes:

determining a position of the rotor based on the induced voltage, and

deciding the drive current based on the position.

The measuring of the induced voltage may be executed after the supplying the starting current.

The measuring of the induced voltage may be executed during the supplying the starting current.

The supplying of the starting current preferably includes:

supplying another starting current for the armature coil, and

supplying the starting current when the rotor is not rotated by the another starting current. The starting current and the another starting current have different waveforms each other.

The method of starting the brushless DC motor is preferably further composed of:

detecting a direction of the rotation, and

stopping the rotor when the direction is not a desirable direction.

The supplying of the drive current preferably includes:

continuously supplying a first drive current for the armature coil till a speed of the rotation becomes a predetermined speed, the first drive current being determined based on the induced voltage, and

supplying a second drive current for the armature coil after the continuously supplying the first drive current, a current flow duration of the second drive current being controlled based on the speed.

The supplying of the drive current preferably includes:

supplying a first drive current for the armature coil such that the rotor is rotated with a maximum torque, till a speed of the rotation becomes a predetermined speed; and

supplying a second drive current for the armature coil after the supplying the first drive current, a current flow duration of the second drive current being controlled based on the speed.

In order to achieve another aspect of the present invention, a brushless DC motor is composed of an armature including an armature coil, a rotor including a plurality of field magnets, a power supply unit, and a measuring unit. The power supply unit supplies a starting current for the armature coil while the rotor is in a stationary state. The measuring unit measures an induced voltage induced in the armature coil by rotation of the rotor that is caused by the starting current. The power supply unit supplies a drive current for the armature coil in response to the induced voltage.

### BRIEF DESCRIPTION OF THE DRAWINGS

FIG. 1A is a view describing a conventional method of starting a brushless DC motor;

FIG. 1B is a view describing the conventional method of starting a brushless DC motor;

FIG. 2 is a view showing a configuration of a conventional brushless DC motor to which another conventional starting method is applied; and

FIGS. 3A, 3B and 3C are views describing still another conventional method of starting a brushless DC motor.

FIG. 4 shows a configuration of a brushless DC motor of an embodiment according to the present invention;

FIG. 5 shows a method of starting a brushless DC motor of the embodiment;

FIG. 6 shows starting patterns; and

FIG. 7 shows potentials of a U-phase line 9a, a V-phase line 9b and a W-phase line.

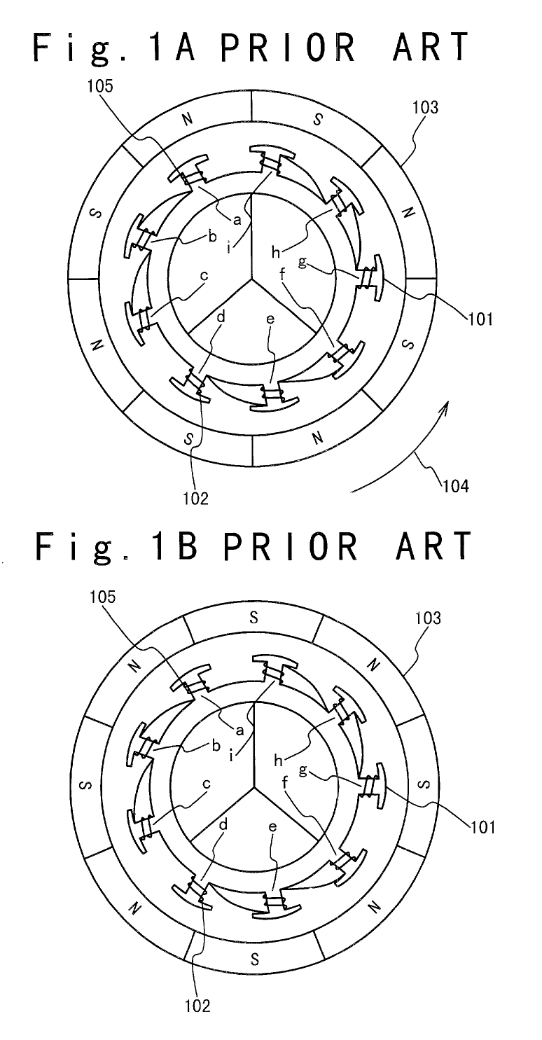

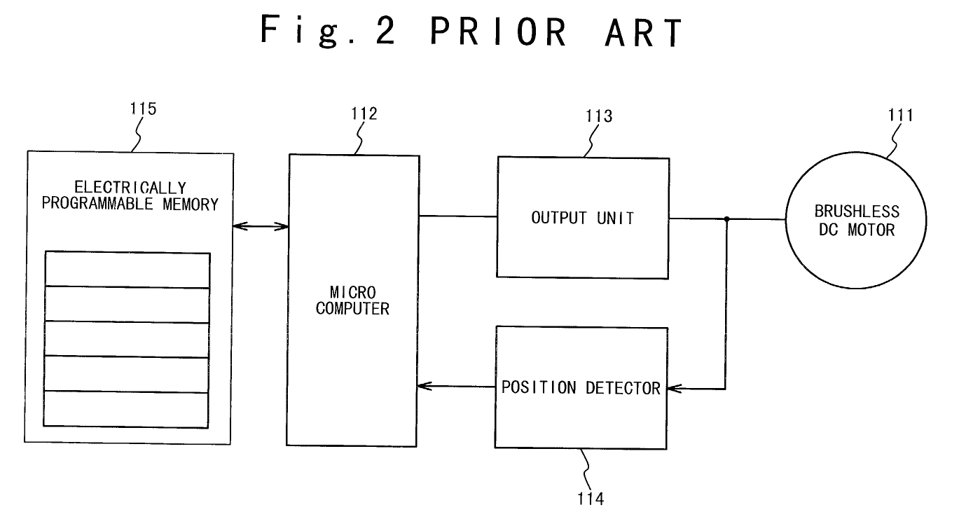

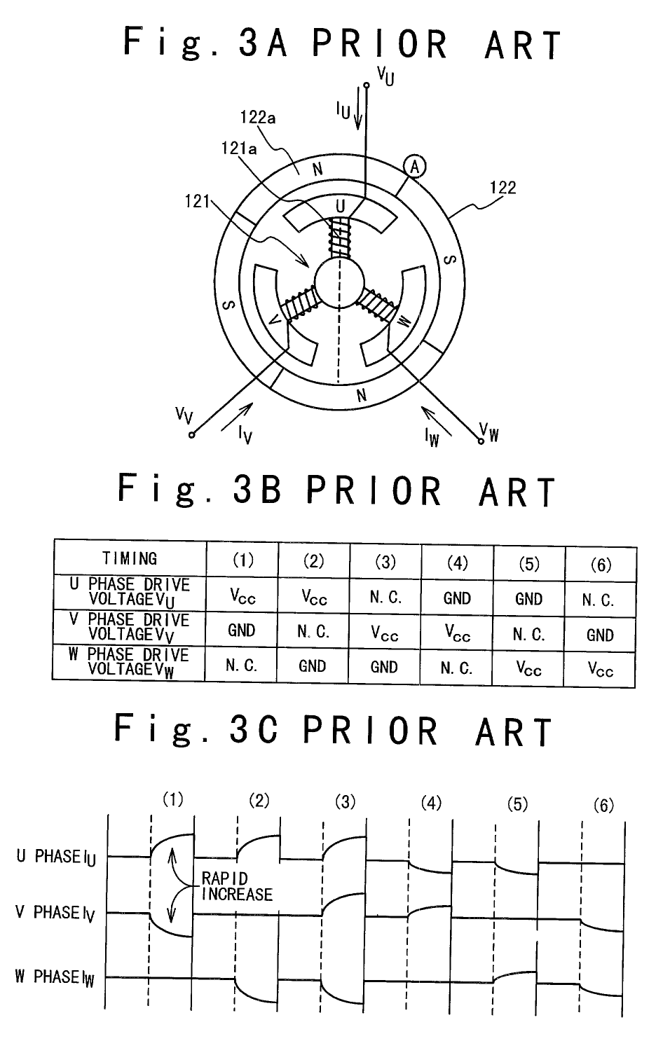

### DESCRIPTION OF THE PREFERRED EMBODIMENTS

A brushless DC motor system according to the present invention and a method of starting the same will be described below with reference to the attached drawings.

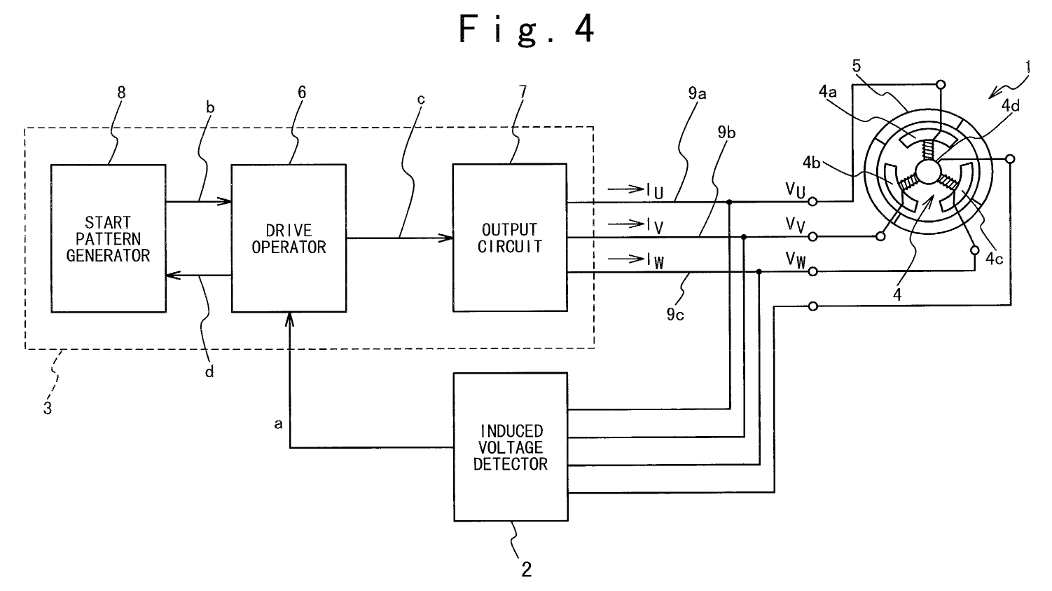

As shown in FIG. 4, the brushless DC motor system of the embodiment according to the present invention is provided with a brushless DC motor 1, an induced voltage detector 2 and a driver 3.

The brushless DC motor 1 contains an armature 4 and a rotor 5. The armature 4 has a U-phase coil 4a, a V-phase coil 4b and a W-phase coil 4c. The U-phase coil 4a, the V-phase coil 4b and the W-phase coil 4c constitute a star connection, being connected at a neutral point 4d. A U-phase line 9a, a V-phase line 9b and a W-phase line 9c are respectively connected to the U-phase coil 4a, the V-phase coil 4b and the W-phase coil 4c. A three-phase armature current are supplied through the U-phase line 9a, the V-phase line 9b and the W-phase line 9c to the U-phase coil 4a, the V-phase coil 4b and the W-phase coil 4c, and the supplied three-phase armature current drives the rotor 5 to rotate.

The induced voltage detector 2 measures the electromotive voltages induced in the U-phase coil 4a, the V-phase coil 4b and the W-phase coil 4c by the rotation of the rotor 5. A potential of the neutral point 4d is used as a standard potential for the measurement of the electromotive voltages. The induced voltage detector 2 sends a voltage measurement signal a to inform the driver 3 of the measured electromotive voltages.

The driver 3 supplies the three-phase armature current to the armature 4 in response to the measured electromotive voltages. The driver 3 supplies the three-phase armature current through the U-phase line 9a, the V-phase line 9b and the W-phase line 9 to the armature 4.

The driver 3 contains a drive operator 6, an output unit 7 and a start pattern generator 8.

The drive operator 6 calculates the position of the rotor 5 on the basis of the measured electromotive voltages. The drive operator 6 determines a supply timing of the three-phase armature current in accordance with the calculated position of the rotor 5 and generates a timing indication signal d to inform the output unit 7 of the supply timing.

The output unit 7 pulls the U-phase line 9a, the V-phase line 9b and the W-phase line 9c up to a power supply potential V_{cc}, or pulls them down to a ground potential, or set them to a floating state, at the timing indicated by the timing indication signal d. That is, the output unit 7 supplies the three-phase armature current to the armature 4 in response to the timing indication signal d.

Here, before the brushless DC motor 1 is started, no electromotive voltage is induced in the U-phase coil 4a, the V-phase coil 4b and the W-phase coil 4c, and the position of the rotor 5 can not be detected. To start the brushless DC motor 1, the starting pattern generator 8 is provided in the driver 3.

The starting pattern generator 8 determines a starting current pattern of the starting current supplied to the armature 4 when the brushless DC motor 1 is started. The start pattern generator 8 outputs a starting pattern indication signal b indicative of the determined starting current pattern to the drive operator 6. When the brushless DC motor 1 is started, the drive operator 6 determines a supply timing of the starting current supplied to the armature 4 in accordance with the starting current pattern, and generates a timing indication signal c. The output unit 7 supplies the current to the armature 4 at the timing indicated by the timing indication signal c.

At this time, even if the starting current is supplied in accordance with the starting current pattern, the brushless DC motor 1 fails to be started. In such cases, the drive operator 6 outputs a start pattern change indication signal d to the start pattern generator 8. The start pattern generator 8 changes the starting current pattern in response to the starting current pattern change indication signal d.

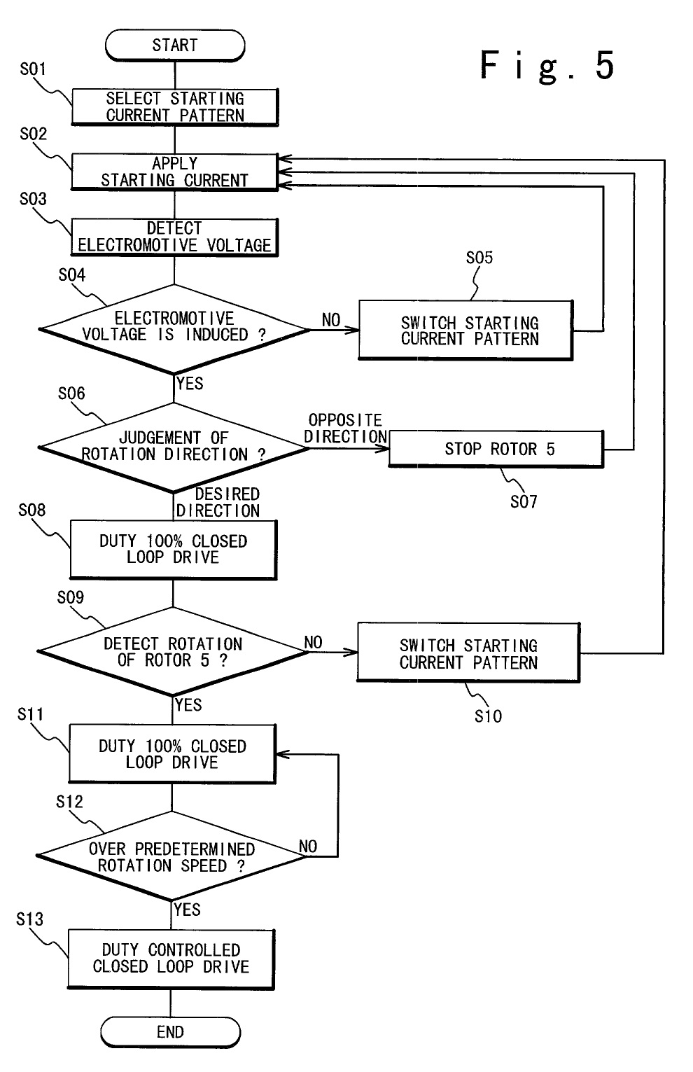

The method of starting a brushless DC motor will be described in detail below with reference to FIG. 5.

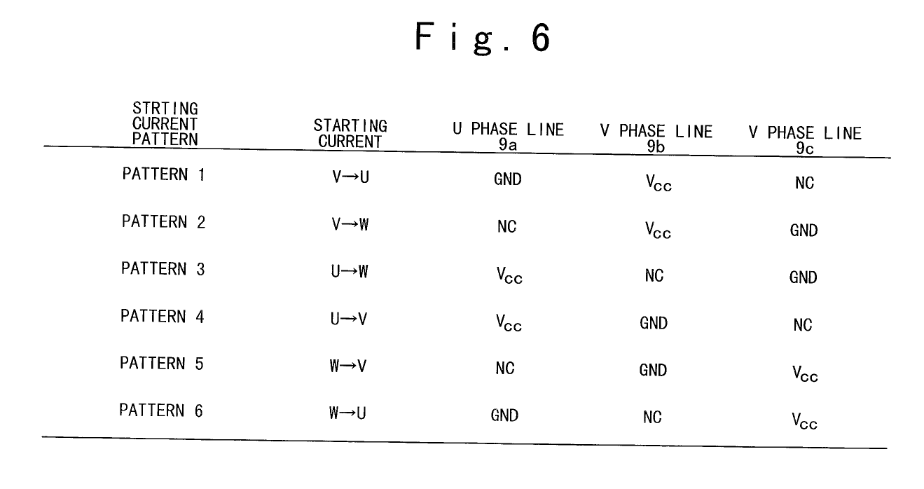

At first, the start pattern generator 8 determines a starting current pattern (Step S01). The starting current pattern is selected from among Patterns 1 to 6 shown in FIG. 6.

If Pattern 1 is selected, a starting current is supplied to flow from the V-phase coil 4b to the U-phase coil 4a. If Pattern 2 is selected, a starting current is supplied to flow from the V-phase coil 4b to the W-phase coil 4c. Similarly, if Patterns 3 to 6 are selected, a starting current is supplied to flow from the U-phase coil 4a to the W-phase coil 4c, from the U-phase coil 4a to the V-phase coil 4b, from the W-phase coil 4c to the V-phase coil 4b, and from the W-phase coil 4c to the U-phase coil 4a, respectively.

Armature voltages applied to the U-phase line 9a, the V-phase line 9b and the W-phase line 9c are determined on the basis of the selected starting current pattern. In FIG. 6, the “GND” s imply the setting at the ground level. The “VCC” s imply the setting at the power supply potential V_{cc}. The “NC” s imply the setting at the floating state.

When the brushless DC motor is started, Pattern 1 is firstly selected as the starting current pattern. The fact that Pattern 1 is selected as the starting current pattern is reported to the drive operator 6 by the starting pattern indication signal b. As described later, when the brushless DC motor 1 is not started by the use of Pattern 1, another pattern among Patterns 2 to 6 is selected as the starting current pattern.

In succession, a starting current is applied to the armature 4 in accordance with the determined starting current pattern (Step S02). At this time, the drive operator 6 outputs the timing indication signal c to the output unit 7 in response to the starting pattern indication signal b to instruct the output unit 7 to supply the starting current from the V-phase to the U-phase for T seconds. The period of T seconds is selected such that it is positively slight within a range in which the rotor 5 can be rotated.

For the T seconds, the output unit 7 sets the U-phase line 9a at the ground level, and sets the V-phase line 9b at the power supply potential V_{cc}, and sets the W-phase line 9c at the floating state to supply the starting current from the U-phase to the V-phase. In many cases, the starting current slightly rotates the rotor 5 by electromagnetic force.

In succession, the electromotive voltage induced by the rotation of the rotor 5 is measured (Step S03). At this time, the output unit 7 sets all of the U-phase line 9a, the V-phase line 9b and the W-phase 9c at the floating state. The slight rotation of the rotor 5 induces the electromotive voltages in the U-phase coil 4a, the V-phase coil 4b and the W-phase coil 4c of the armature 4. The induced electromotive voltages are measured from the potentials of the U-phase line 9a, the V-phase Line 9b, the W-phase line 9c and the neutral point 4d of the armature 4, respectively. The measured electromotive voltages are reported on the voltage measurement signal a to the drive operator 6.

The electromotive voltage may be measured while the starting current is applied to the armature 4. As described above, at the time of the starting, the starting current flows from the U-phase to the V-phase, and the W-phase line 4b is set at the floating state. The electromotive voltage induced in the W-phase coil 4c can be measured while the starting current flows from the U-phase to the V-phase. For the application of the starting current in accordance with another starting current pattern, it is also possible to measure the electromotive voltage of one coil to which the current is not applied, among the U-phase coil 4a, the V-phase coil 4b and the W-phase coil 4c. The measurement of the electromotive voltage during the application of the starting current reduces the time required for starting the brushless DC motor.

In succession, the drive operator 6 judges whether or not the electromotive voltage is induced in the armature 4 (Step S04). If the rotor 5 does not rotate, no electromotive voltage is induced in the armature 4. A different operation is carried out depending on whether or not the electromotive voltage is induced in the armature 4.

If the electromotive voltage is not induced in the armature 4, the drive operator 6 can not specify the position of the rotor 5. In this case, the starting current pattern is switched to another pattern (Step S05). Moreover, the starting current is applied to the armature 4 in accordance with the switched starting current pattern (Step S02). The operation for switching the starting current pattern is done until the slight rotation of the rotor 5 induces the electromotive voltage in the armature 4.

If the electromotive voltage is induced in the armature 4, the drive operator 6 judges the rotation direction of the rotor 5 on the basis of the back electromotive voltage (Step S06).

If the drive operator 6 judges that the rotor 5 is rotated in an opposite direction of a desired direction, the drive operator 6 fails to supply drive currents to the armature 4 to stop rotation of the rotor 5 (Step S07). In this case, the operations from the application of the starting current pattern (Step S02) to the judgement of the rotation direction of the rotor 5 (Step S06) are executed once again.

If the drive operator 6 judges that the rotor 5 is rotated in the desired direction, the drive operator 6 carries out a closed loop drive (Step S08). The drive operator 6 detects the position of the rotor 5 on the basis of the electromotive voltage induced in the armature 4. Then the drive operator 6 determines the drive current to be supplied to the U-phase coil 4a, the V-phase coil 4b and the W-phase coil 4c on the basis of the detected position. In succession the drive operator 6 supplies the determined drive current to drive the rotor 5. Once the rotation of the rotor 5 is started, the position of the rotor 5 is then detected on the basis of the electromotive voltages induced in the armature 4, and the rotor 5 is driven in response to the detected position of the rotor 5.

At this time, the closed loop drive is done while the duty of the drive current is set to substantially 100%. Here, when the drive current is supplied only for τ (seconds) between two phases among the U-phase, the V-phase and the W-phase in a certain period having a length of T₁ (seconds), a duty D is defined as follows:

D=τ/T₁

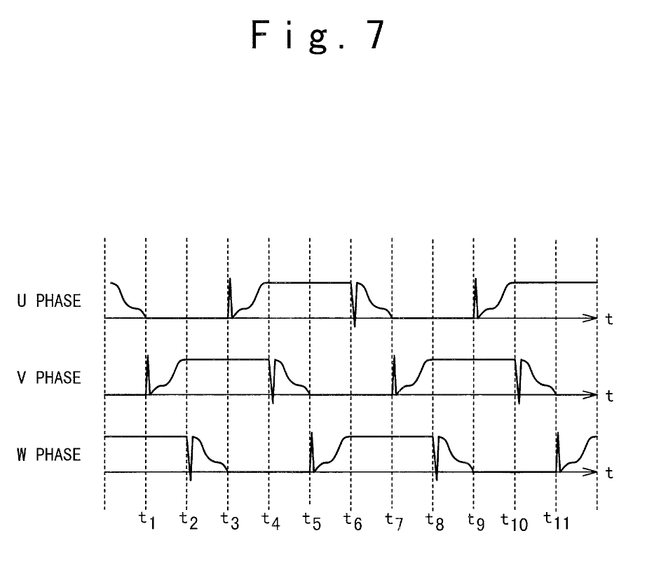

The fact that the duty is 100% implies that the drive current is continuously supplied between the two phases among the U-phase, the V-phase and the W-phase at any time. FIG. 7 shows the potentials of the U-phase line 9a, the V-phase line 9b and the W-phase line 9c when the duty is 100%. With reference to FIG. 7, from a time t₁, to a time t₂, the W-phase line 9c is set at the power supply potential V_{cc}, and the U-phase line 9a is set at the ground level. That is, from the time t₁ to the time t₂, the drive current is supplied from the W-phase of the armature 4 to the U-phase. From the time t₂ to a time t₃, the V-phase line 9b is set at the power supply potential V_{cc}, and the U-phase line 9a is set at the ground level. That is, from the time t₂ to the time t₃, the drive current is supplied from the V-phase of the armature 4 to the U-phase. In this way, when the duty is 100%, one line among the U-phase line 9a, the V-phase line 9b and the W-phase line 9c is set at the power supply potential V_{cc} at any time, and another one line is further set at the ground level. Thus, the drive current is supplied between the two phases among the U-phase, the V-phase and the W-phase. While the closed loop drive is done with the duty substantially 100%, a possibly maximum torque can be applied to the rotor 5.

In succession, the drive operator 6 judges whether or not the rotor 5 is rotated (Step S09). As mentioned above, since the starting current is applied to the armature 4 in accordance with the determined starting current pattern, the rotor 5 is usually slightly rotated. However, if the torque applied to the rotor 5 is weak at this time, the start of the above-mentioned closed loop drive (Step S08) may result in the stop of the rotation of the rotor 5. Therefore, the drive operator 6 judges whether or riot the rotor 5 is rotated on the basis of the electromotive voltage induced in the armature 4.

If the rotor 5 is not rotated, the starting current pattern is switched to another starting current pattern (Step S10). Moreover, the operations from the application of the starting current pattern (Step S02) to the closed loop drive at which the duty is 100% (Step S08) are executed once again.

If the rotor 5 is rotated, the closed loop drive at which the duty is 100% is continued (Step S11). The closed loop drive at which the duty is 100% is continued until the speed of rotation of the rotor 5 reaches the predetermined speed of rotation (Step S12).

After the speed of rotation of the rotor 5 reaches the predetermined speed of rotation, the closed loop drive is executed while the duty is controlled on the basis of the speed of rotation of the rotor 5 (Step S13). The control of the duty enables the desirable torque to be applied to the rotor 5 to control the rotation speed of the rotor 5. The starting of the brushless DC motor is completed by the above-mentioned processes.

In the above-mentioned method of actuating a brushless DC motor, The judgment of the rotation direction in Step SO6 may be canceled (Step S06). Also in this case, the rotor 5 is rotated in the desired rotation direction, since the closed loop drive is done on the basis of the detected position of the rotor 5. However, if the judgment of the rotation direction (Step S06) is not done, the rotor 5 may be reversed to rotate in the desired direction when the stating current rotates the rotor 5 in the opposite direction of the desired direction. Thus, it is desirable that the judgment of the rotation direction (Step S06) is done.

The brushless DC motor in this embodiment and the method of starting the same need not wait for the situation that the rotor 5 is locked at a certain position. The brushless DC motor and method of starting the same reduces the time necessary for the actuation.

Also, in the brushless DC motor and the method of starting the same, it is not necessary to use the memory having the large circuit size. Moreover, the brushless DC motor and the method of starting the same, it is not necessary to mount the analog circuit. In the brushless DC motor and the method of actuating the same, it is possible to reduce the circuit sizes of the induced voltage detector 2 and the driver 3. Moreover, in the brushless DC motor and the method of actuating the same, if the induced voltage detector 2 and the driver 3 are integrated into LSI, it is possible to reduce the occupation area.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A method of starting a brushless DC motor including an armature coil in a stator and field magnets in a rotor, comprising:
supplying a starting current for said armature coil while said rotor is in a stationary state;
measuring an induced voltage induced in said armature coil by rotation of said rotor wherein said rotation is caused by said starting current; and
supplying a drive current for said armature coil in response to said induced voltage.

2. The method according to claim 1, wherein said supplying said drive current includes:
determining a position of said rotor based on said induced voltage, and
deciding said drive current based on said position.

3. The method according to claim 1, wherein said measuring is executed after said supplying said starting current.

4. The method according to claim 1, wherein said measuring is executed during said supplying said starting current.

5. The method according to claim 1, wherein said supplying said starting current includes:
supplying another starting current for said armature coil, and
supplying said starting current when said rotor is not rotated by said another starting current, and
said starting current and said another starting current have different waveforms each other.

6. The method according to claim 1, further comprising:
detecting a direction of said rotation; and
stopping said rotor when said direction is not a desirable direction.

7. The method according to claim 1, wherein said supplying said drive current includes:
continuously supplying a first drive current for said armature coil. till a speed of said rotation becomes a predetermined speed, said first drive current being determined based on said induced voltage, and
supplying a second drive current for said armature coil after said continuously supplying said first drive current, a current flow duration of said second drive current being controlled based on said speed.

8. The method according to claim 1, wherein said supplying said drive current includes:
supplying a first drive current for said armature coil such that said rotor is rotated with a maximum torque, till a speed of said rotation becomes a predetermined speed; and
supplying a second drive current for said armature coil after said supplying said first drive current, a current flow duration of said second drive current being controlled based on said speed.

9. A brushless DC motor comprising:
an armature including an armature coil;
a rotor including a plurality of field magnets;
a power supply unit; and
a measuring unit, wherein said power supply unit supplies a starting current for said armature coil while said rotor is in a stationary state, and
said measuring unit measures an induced voltage induced in said armature coil by rotation of said rotor, said rotation being caused by said starting current, and
said power supply unit supplies a drive current for said armature coil in response to said induced voltage.

10. The brushless DC motor according to claim 9, wherein said power supply unit determines a position of said rotor based on said induced voltage, and decides said drive current based on said position.

11. The brushless DC motor according to claim 9, wherein said measuring unit measures said induced voltage after said power supply unit finishes supplying said starting current.

12. The brushless DC motor according to claim 9, wherein said measuring unit measures said induced voltage while said power supply unit supplies said starting current.

13. The brushless DC motor according to claim 9, wherein said power supply unit supplies another starting current for said armature coil, and supplies said starting current when said rotor is not rotated by said another starting current, said starting current and said another starting current having different waveforms each other.

14. The brushless DC motor according to claim 9, wherein said power supply unit detects a direction of said rotation, and stops supplying said drive current when said direction is not a desirable direction.

15. The brushless DC motor according to claim 9, wherein said power supply unit continuously supplies said drive current for said armature coil till a speed of said rotation becomes a predetermined speed, said drive current being determined based on said induced voltage, and
said power supply unit supplies said drive current for said armature coil, controlling a current flow duration of said drive current based on said speed after said speed becomes said predetermined speed,

16. The brushless DC motor according to claim 9, wherein said power supply unit supplies said drive current for said armature coil such that said rotor is rotated with a maximum torque, till a speed of said rotation becomes a predetermined speed, and
said power supply unit supplies said drive current for said armature coil after said supplying said first drive current, controlling a current flow duration of said drive current based on said speed.
